(19) United States
(12) Patent Application Publication
(10) Pub. No.: US 2005/0218632 A1
(43) Pub. Date: Oct. 6, 2005

(54) Restorable vehicle occupant safety system

(76) Inventors: Jess Cuevas, Scottsdale, AZ (US); Sanjeev M. Kulkarni, Tempe, AZ (US)

Correspondence Address: Squire, Sanders & Dempsey L.L.P.;Two Renaissance Square, 40 North Central Avenue, Suite 2700, Phoenix, AZ, 85004-4498, US

(21) Appl. No.: 10/813,400

(22) Filed: Mar. 31, 2004

(51) Int. Cl. B60R 21/16; B60R 21/22

(52) U.S. Cl. 280/730.1; 280/728.1

(57) ABSTRACT

A Restorable Vehicle Occupant Safety System to replace present pyrotechnic airbag systems. The system is comprised of an air pressure storage vessel 21 that is fluidly connected to an air distribution manifold 36, electronic sensors that preclude an impending crash, valves which are sensor activated to inflate airbags for driver, passenger, knee bolster, side impact, and rollover units as well as seatbelt pre-tensioning units. The present system will safely deploy the airbags in a substantially safe increment of time before a crash condition and restore the airbags to their original position in the event the crash condition does not occur.

### BACKGROUND OF THE INVENTION

1. Technical Field

The present invention relates to a restorable non-pyrotechnic vehicle airbag safety system. In particular the present invention relates to an airbag system that deploys at a proper and safe time element before a collision occurs. Sensors on the vehicle will detect an impending collision and cause the deployment of the airbag system through pneumatic valves from a compressed air cylinder which is fed by the vehicle air compressor. If no collision occurs, the airbags will retract to their original restored positions.

2. Description of the Prior Art

1. Inflatable vehicle occupant protection devices, such as airbags are known. The airbag is inflated by pyrotechnic fluid provided by an inflator. The airbag typically inflates to a location between the occupant and a vehicle part to protect the occupant from forcefully striking or being struck by the vehicle part.

The airbag and inflator are are commonly mounted to a plate to form a module. Modules are attached to the steering wheel or a substantially robust force reaction cannister structure (passenger side) in the vehicle instrument panel.

Present airbag inflator systems contain propellant grains, ignition enhancers, gas filters, and pyrotechnic initiators. These systems require electric ignition and produce substantially high gas pressures. They also produce substantially hot and toxic gasses that are released into the vehicle thru airbag vents at deployment. These features can, and have, on occasion, caused injury to vehicle occupants during a collision, particularly when the occupant is out-of position. The time element between vehicle collision and occupant movement is so fast that these systems must deploy in milliseconds. This fast time element deployment produces a substantially high noise, especially when several inflators are deployed, such as knee bolsters, side impact modules, rollover inflators and seat belt pretensioners.

Present pyrotechnic systems require that the manufacturing and assembly line include:

1. propellant manufacturing facilities

2. propellant assembly station

3. propellant enhancer assembly station

4. filter manufacturing facility

5. filter assembly station

6. pyrotechnic initiator

7. pyrotechnic initiator assembly station

8. initiator electrical checkout station

9. driver side airbag folding station

10. Inflator stamping facilities

11. Inflator welding stations

12. Dual stage designs for out of position occupants (different gas outputs)

13. driver side module plate stamping facility

14. passenger side airbag force reaction can stamping facility

15. passenger side airbag folding station

### SUMMARY OF THE INVENTION

To avoid the limitations and problems of present pyrotechnic systems and manufacturing functions, the following are design objectives:

An object of the system invention is to eliminate pyrotechnic initiators and inflators to obtain a safer vehicle interior environment at airbag deployment.

Another object of the invention is to utilize the use of sensors that detect an oncoming vehicle distance, velocity, and configuration and thus make the decision to deploy the particular vehicle airbag before the collision occurs.

Another object of the invention is to slow the rate of airbag inflation by anticipating the collision event and deploy the airbags sooner and slower thus creating a safer environment for the occupant, especially for occupants in an out-of-position condition.

Another object of the invention is to retract the airbags to their original stored positions in the event the collision does not occur.

Another object of the invention is to eliminate the need to fold driver side and passenger side airbags.

Another object of the invention is to make available, a non-pyrotechnic airbag system that can be used in school buses, passenger trains, and commercial airlines.

The present invention is a system comprising a compressed air container, driver and passenger airbag designs, as well as side impact, rollover, and knee bolster airbag features. Driver and passenger designs will include a storage cylinder where the airbag will be stored in an inverted tensile condition as shown in FIGS. 6 and 8. Side impact and knee bolster features are configured in parallel sewed channels and will be retracted by their respective resilient covers as shown in FIGS. 1 and 4.

The electronic portion of the invention will be supplied by, for example, Trisys Inc. and Microchip Technologies that utilyze a pre-crash sensing module consisting of an automotive grade micro-controller, a G-sensor, an ultrasonic and Infrared position sensors for sensing the distance and the speed of an approaching vehicle and sending a signal to the valves that activate the vehicle airbag safety system. A schematic of the system is shown in FIG. 10.

The micro-controller evaluates the accelerometer and position sensor outputs to determine if an event is occurring (i.e., sensing acceleration/deceleration above threshold, magnitude, and duration and the position of the approaching vehicle as a function of time). The micro-controller is flash memory based and can be upgraded and/or programmed on the fly. The micro-controller will have additional functions such as detecting a false trigger vs. a true trigger and performing diagnostic functions such as continually checking the system against power failure. Once the event has been validated, the micro-controller commands a valve to actuate.

The pre-crash sensing module will determine if a collision is about to occur by using a heuristic algorithm that asks the following questions:

1. Is there an object approaching?

2. How fast is this object approaching?

3. What is the speed of your vehicle?

4. What is the relative speed of your vehicle?

Then the electronic system/module makes a decision depending on the answers, whether the restorable safety system should deploy or not.

In the event that the collision does not occur, the airbag systems will deflate by opening a dump valve to allow the airbags to retract to their original positions. The driver and passenger module designs will have commercially available constant force spring retraction systems from, for example, Vulcan Spring & Mfg. Co, Telford, Pa., as well as a pneumatic (vaccuum) retraction system and are illustrated in stored and deployed conditions in FIGS. 6, 7, 8 and 9. Air directed to the vehicle doors for side impact protection will be thru flexible convoluted hoses substantially similar to present electrical hoses used to house the wiring for window and door locking controls.

In the event of an impending collision condition, sensors will activate valves located at the domed ends of a compressed air tank as shown in FIGS. 1 and 5. Compressed air will be directed thru flexible hoses to the respective airbag stations and seatbelt pre-tensioning units, and will be anchored to substantially robust distribution fittings with standard hose clamps. Air will then be released from the system to facilitate the retraction and restoring of the airbags.

Air from the system will be released and maintained to the knee bolster and side impact stations to a portion of the deployment pressure when the vehicle is started. This feature will enhance a faster deployment time as well as provide an air accumulator function to avoid inflation shock.

### BRIEF DESCRIPTION OF THE DRAWINGS

Further features and advantages of the present invention will become apparent to those skilled in the art to which the present invention relates from reading the following description with reference to the accompanying drawings, in which:

FIG. 1 is a schematic view of the vehicle airbag system showing the side impact feature at the vehicle doors. The air tank (reservoir) can also be located behind the rear seat in the trunk or in the behind the instrument panel.

FIG. 2 is a schematic view of the vehicle airbag system showing the driver side knee bolster position as well as the steering wheel face bag system with it's integrated bag storage cylinder.

FIG. 3 is a schematic view of the vehicle airbag system showing the passenger knee bolster position as well as the passenger airbag with it's airbag storage cylinder.

FIG. 4 is a schematic view a typical door section showing the inflated side impact airbag channels as well as the air entry port and resilient elastomeric retracting cover.

FIG. 5 is a schematic top view of the vehicle air circuit.

FIG. 6 is a schematic sectional view of the driver's steering wheel module showing the airbag in it's inverted stored condition. The airbag is mounted on a present steering wheel module plate surface. Also shown is a banjo type rotational air inlet fitting, steering wheel bearings and the splined steering shaft interface

FIG. 7 is a schematic sectional view of the steering wheel module showing the airbag in it's deployed condition. (Internal tethering will mitigate inflated airbag loads.)

FIG. 8 is a schematic sectional view of the passenger side module showing the airbag in it's inverted and stored condition.

FIG. 9 is a schematic sectional view of the passenger side module showing the airbag in it's deployed condition. The airbag mouth is attached to the instrument panel thru a compression clamp.

FIG. 10 shows a schematic of the electronic sensor system as well as a top view of the vehicle sensor positions.

### DESCRIPTION OF A PREFERRED EMBODIMENT

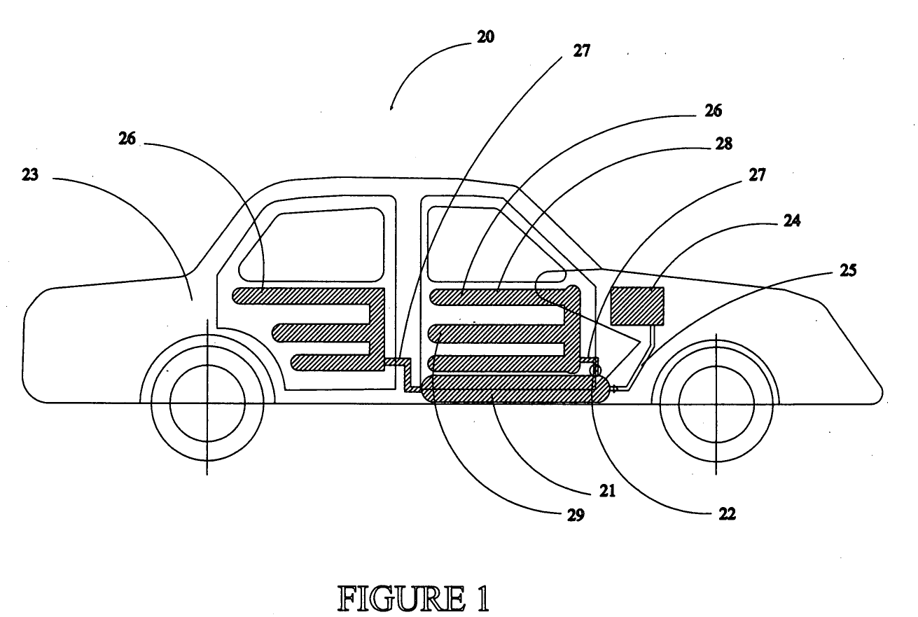

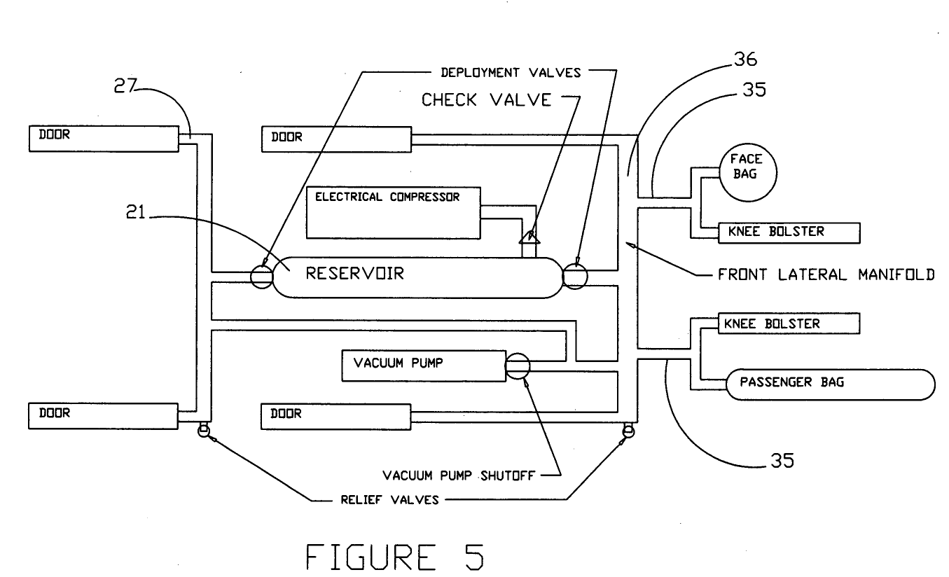

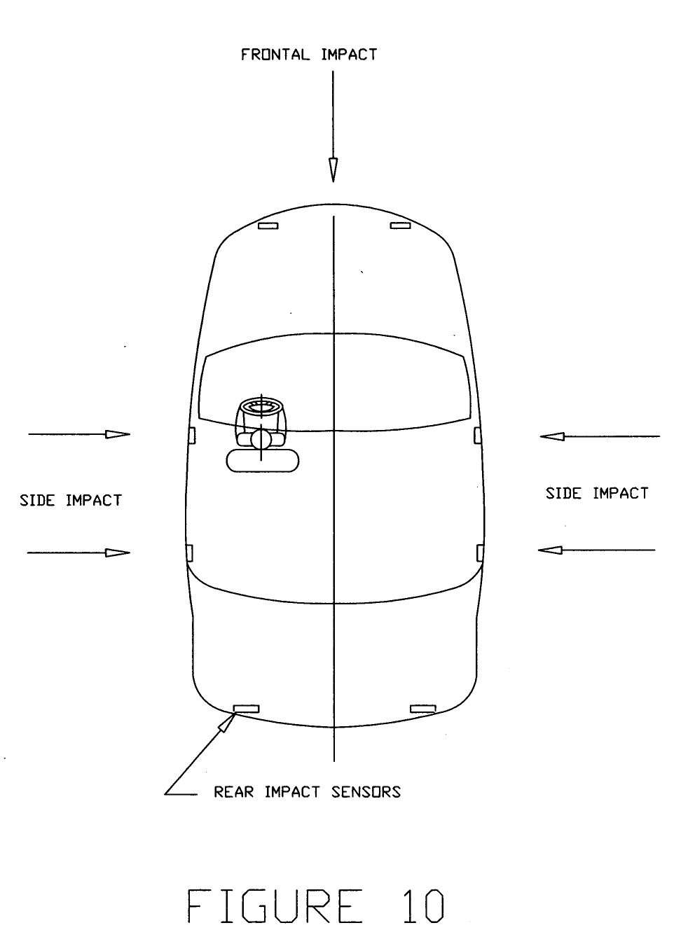

A restorable vehicle occupant safety system 20 embodying the present invention is illustrated in FIG. 1. A compressed air reservoir 21 is mounted parallel to the driveshaft of vehicle 20 and utilizes an electrically operated deployment valve 22 which is initiated by the vehicle collision detecting sensor system shown in FIG. 10. The reservoir can also be mounted behind the back seat, in the trunk in area 23 or in the instrument panel. The vehicle compressor 24 is fluidly connected to reservoir 21 thru pressure line 25. Air pressure from the reservoir 21 is fluidly connected to the manifold 36 (FIG. 5) and door mounted side impact airbag modules 26 thru convoluted pressure hoses 27. Top airbag channel 28 is separated from channel 29 to provide space for door and window controls.

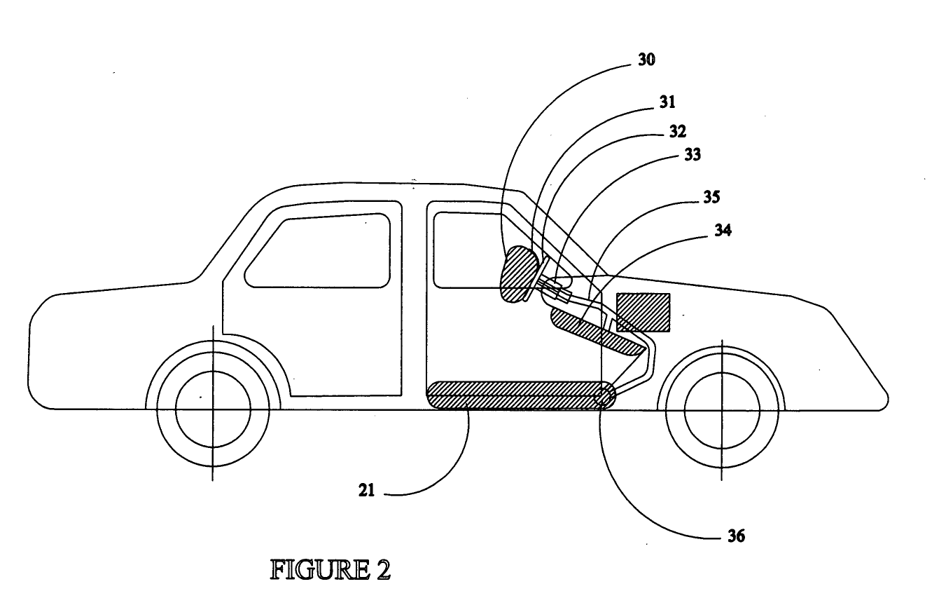

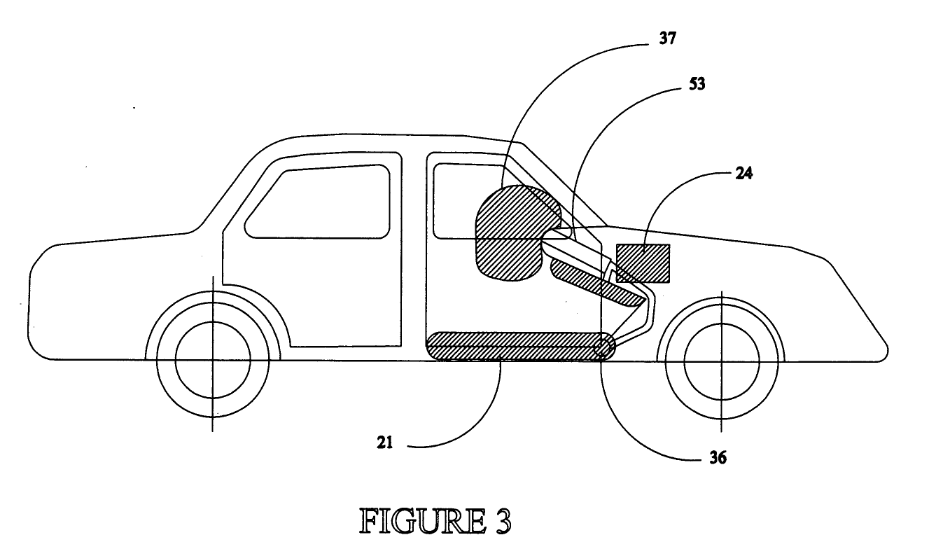

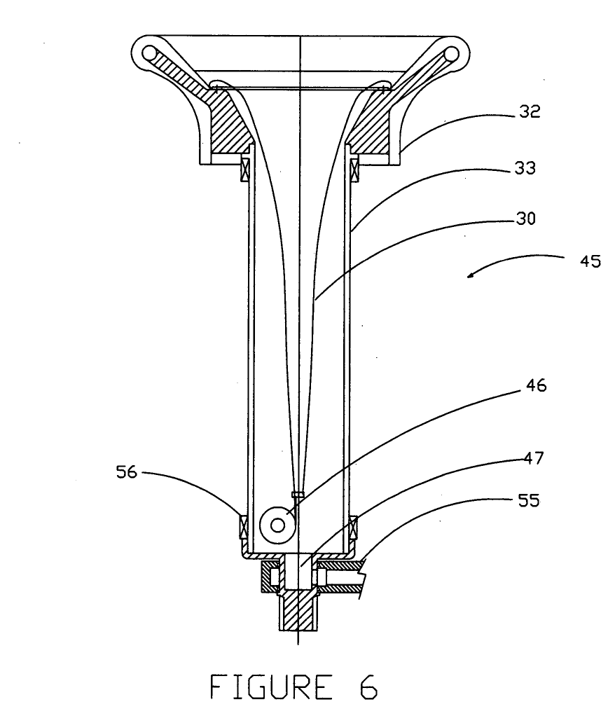

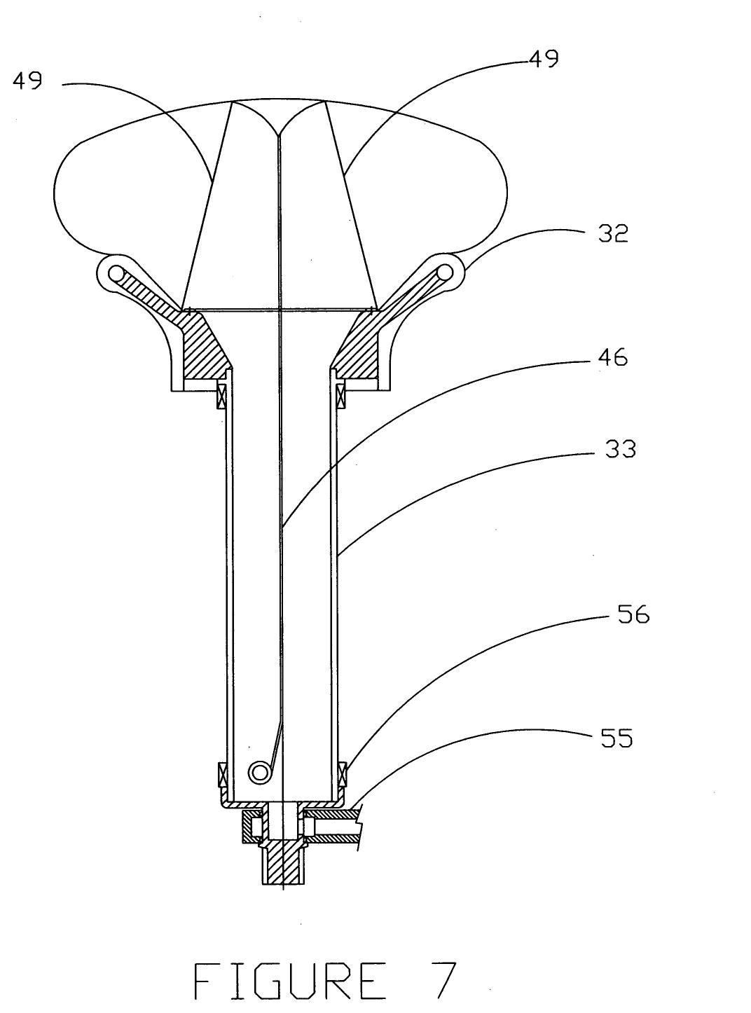

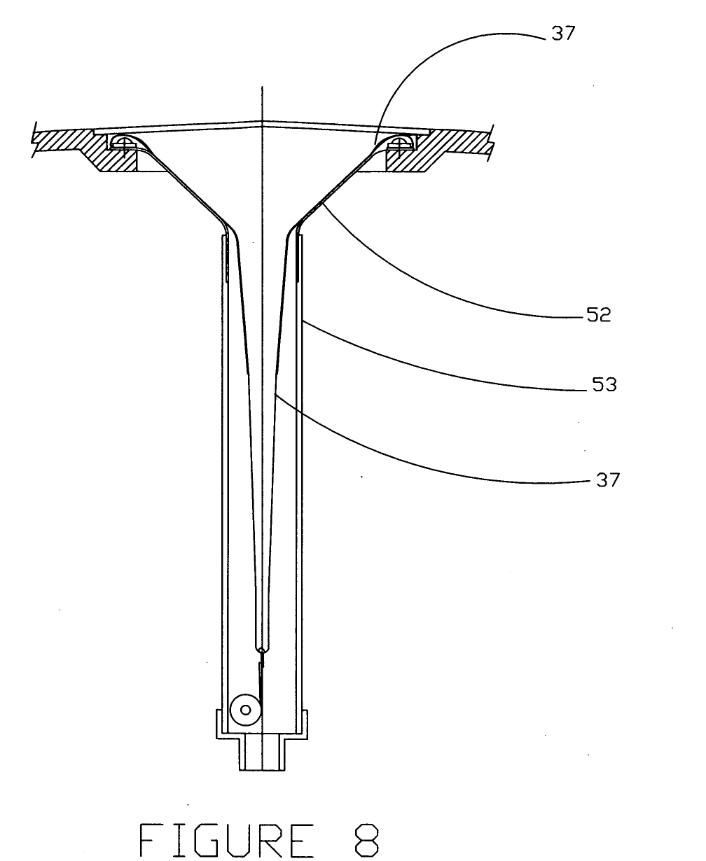

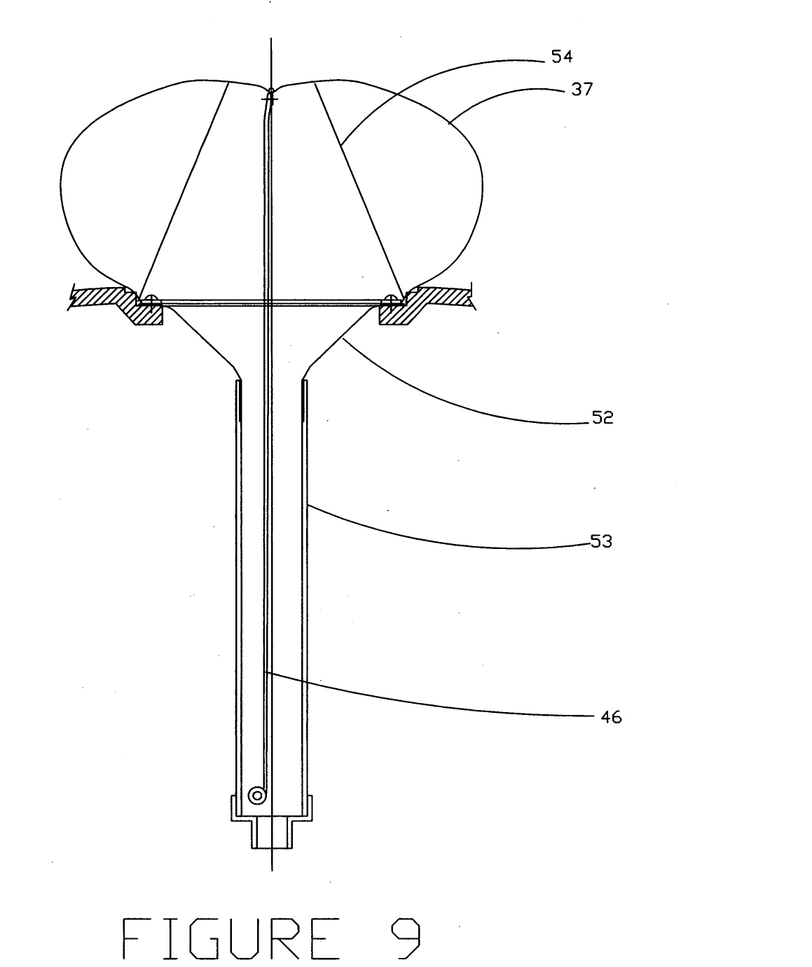

A view with the driver side face airbag 30 (FIG. 2), is shown in its inflated condition with spring-loaded airbag cover 31 in the open position. Airbag covers will return to their respective original positions and be maintained in place thru magnetic linear strips to prevent vibration of the covers. Steering wheel 32 with integral airbag storage cylinder 33 and knee bolster 34 are shown fluidly connected to pressure hose 35, which terminates at the lateral manifold 36. Air will enter the lower end of the driver side module 45 (FIG. 6 and FIG. 7) which is mounted in bearings 56, thru a rotatable air inlet fitting 55 and entry 47 to inflate the airbag within integral airbag restoring cylinder 33 and knee bolster module 34, both fluidly connected to lateral manifold 36. In like manner, air will enter the lower end of the passenger side module 53 (FIG. 8) with airbag 37 shown in a tensile condition to inflate the module (FIG. 9 and FIG. 3). The action of the airbag inflation will cause the constant force spring assembly 46 to extend at full deployment. The spring assembly will then retract and restore the airbag thru funnel 52 and into the restoring cylinder 53 when the system air pressure is released. Tethers 54 and 49 (FIG. 9 and FIG. 7) will contain the airbag at full inflation to prevent the spring assembly from absorbing the terminal inflation force.

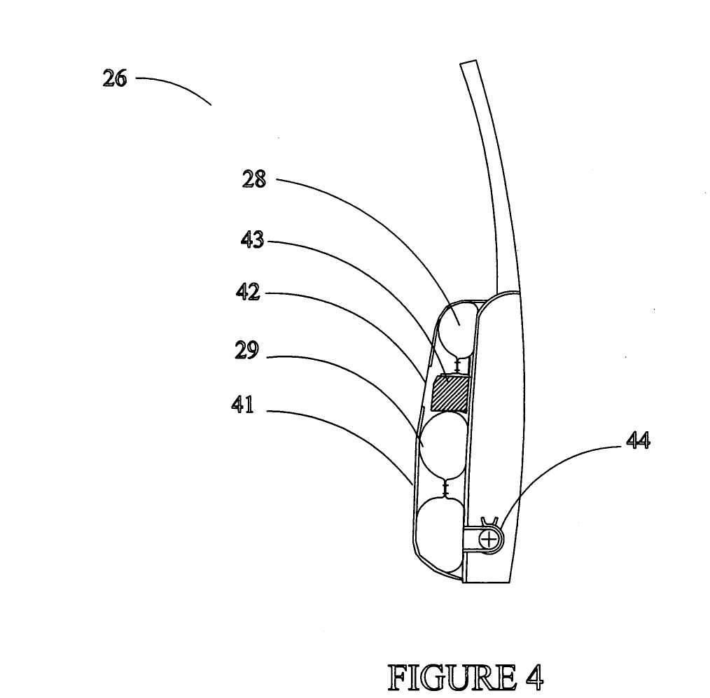

Air flow will enter vehicle doors (FIGS. 1 and 4) to inflate the channels 28 and 29 of modules 26 thru inlet 44 of the side impact airbag modules which will be retracted by resilient retracting covers 41. An opening 42 in the cover will access the door latch and window control area.

Although the invention is described with respect to the preferred embodiment, modifications thereto will be apparent to those skilled in the art. Therefore, the scope of the invention is to be determined by the claims that follow:

1. A restorable vehicle airbag safety system that deploys the proper airbags upon a signal from a sensor system before a collision occurs and retracts and restores said airbags to their respective original positions in the event the collision does not occur, without the use of pyrotechnic means.

2. A driver side and passenger side airbag designs that utilize a constant-force spring to return the airbag to it's original position, said airbag being stored in an inverted tensile condition.

3. A driver side airbag design that utilizes a container that defines a chamber to house said airbag, said container mounted on bearings, and being directly connectable to the steering shaft of the vehicle.

4. A restorable vehicle airbag safety system that requires no bag folding for storage.

5. A restorable vehicle airbag safety system that features an optional redundant negative pressure system to retract said airbags, said system being operated from a vehicle vacuum pump.

6. A restorable vehicle airbag safety system that features spring-loaded airbag covers that close over said airbags on the driver and passenger modules when the system pressure is released overboard.

7. The system of claim 1 wherein no toxic gasses are released into the vehicle interior at airbag deployment.

8. A restorable vehicle airbag safety system that allows a portion of the deployment pressure when starting the vehicle, to the air distribution manifold, knee bolster and side impact positions to reduce the time to full deployment and to reduce deployment shock to the system, thus assuming the function of an air accumulator container.

9. The system of claim 1 whose features of passenger side and side impact modules may be utilized in school buses, passenger trains, and commercial airlines.
